(19) United States
(12) Patent Application Publication
(10) Pub. No.: US 2004/0257071 A1
(43) Pub. Date: Dec. 23, 2004

(54) Angular position sensor

(76) Inventor: Jack Chen, Oak Brook, IL (US)

Correspondence Address: Robert L. Marsh, P.O. Box 4468, Wheaton, IL, 60189-4468, US

(21) Appl. No.: 10/600,103

(22) Filed: Jun. 20, 2003

(51) Int. Cl. G01B 7/30

(52) U.S. Cl. 324/207.25; 324/207.2; 324/207.15

(57) ABSTRACT

A rotational position sensor includes a rotor having a magnetic member thereon, with a positive pole positioned at one point on the outer circumference of the rotor and a negative pole on the circumference of the rotor 180 degrees from the positive pole. The angular position sensor includes a housing with a detector thereon for detecting the magnetic polarity of the portion of the rotor nearest the detector. The output from the detector is an AC current, the wave of which is indicative of the angular orientation of the shaft around which the rotor is mounted.

The present invention relates to an improved angular position sensor having a rotor rotating within a housing that does not require brushes for making electrical contact between the housing and the rotor.

### BACKGROUND OF THE INVENTION

An angular position sensor detects the angular orientation of a rotating shaft with respect to a housing. It may be desirable, for example, to know exactly when a rotating shaft is in a given angular orientation and therefore it is desirable to monitor the angular orientation of a shaft as it rotates about its longitudinal axis.

Existing angular position sensors consist of a rotor which fits around the circumference of the shaft and rotates with the shaft, and a housing which surrounds the rotor and remains stationary. A pair of annular concentric resistive contacts are positioned on an inner surface of the housing. The annular resistive contacts do not extend around 360 degrees, but have a break therein such that each of the resistive contacts form an incomplete circle. A pair of electrically connected brushes joined by a shunt are mounted on the rotor to form an electrical connection across the two concentric. An electrical potential is applied across one of the pairs of resistive members on the housing and one end of the other concentric resistive contact is connected through an ammeter to ground. The ammeter measures the current through the second resistive member which changes as the rotor rotates within the housing, thereby providing a measure of the angular orientation of the brush with respect to the housing. Such prior art rotational position sensors require an electrical contact between the brush of the rotor and the resistive contact of the housing to provide an electrical readout indicative of angular orientation.

Angular position sensors are often not mounted in the immediate proximity of a bearing and are subject to differential vibration as the shaft rotates. Differential vibration has resulted in contact and friction between the rotating rotor and the stationary housing loosening fine particles of plastic that have interfered with the contact between the of such prior art rotational position sensors. It would be desirable to provide a rotational position sensor which does not rely upon the contact between brushes and a contact surface to provide a readout of angular orientation.

### SUMMARY OF THE INVENTION

Briefly, the present invention is embodied in a angular position sensor for reading the angular orientation of a shaft with respect to a stationary body. The angular positional sensor includes a rotor having a bore sized to receive the shaft and the rotor has at least one magnetic member thereon. In a preferred embodiment, a single annular magnetic member having a central opening and a circular outer circumference is provided. The central opening of the magnetic member has a diameter larger than the central opening of the rotor and is coaxial therewith. The magnetic member has a positive pole at a first position on the circumference of the rotor and a negative pole at a second position on the circumference of the rotor which is 180 degrees from the first position.

A clamshell housing surrounds a portion of the rotor and means are provided on the housing to retain the housing stationary against rotation with the shaft. Positioned on the housing near the outer circumference of the rotor is a magnetic detecting means for detecting the polarity of the portion of the rotor nearest the detection means. The device further includes means responsive to the detection means for generating a wave indicative of the magnetic polarity detected by the detection means, whereby the wave is indicative of the angular orientation of the shaft with respect to the stationary member.

A hall effect detector, or a coil may be used to detect the magnetic polarity of the portion of the rotor nearest the detector. The device may further include an analog to digital converter for converting the analog wave produced by the detector into a digital output. A microcomputer may also be provided to convert the digital output into a numerical reading such as degrees.

### BRIEF DESCRIPTION OF THE DRAWINGS

A better understanding of the present invention will be had after reading of the following detailed description taken in conjunction with the drawings, wherein

FIG. 1 is an isometric view of a rotating shaft having a rotational position sensor in accordance with the prior art mounted thereon;

FIG. 2 is a cross-sectional view of the rotational position sensor shown in FIG. 1;

FIG. 3 is an elevational view of an inner surface of the first housing member;

FIG. 4 is an exploded view of the rotational position sensor shown in FIG. 1;

FIG. 5 is an exploded cross sectional view of angular position sensor in accordance with the present invention;

FIG. 6 is an exploded isometric view of the angular position sensor shown in FIG. 5;

FIG. 7 is a front elevational view of the rotor for the angular position sensor shown in FIG. 5;

FIG. 8 is a block diagram of the electric elements of the present invention; and

FIG. 9 is an exploded isometric view of a second embodiment of an angular position sensor in accordance with the present invention.

### DETAILED DESCRIPTION OF A PREFERRED EMBODIMENT

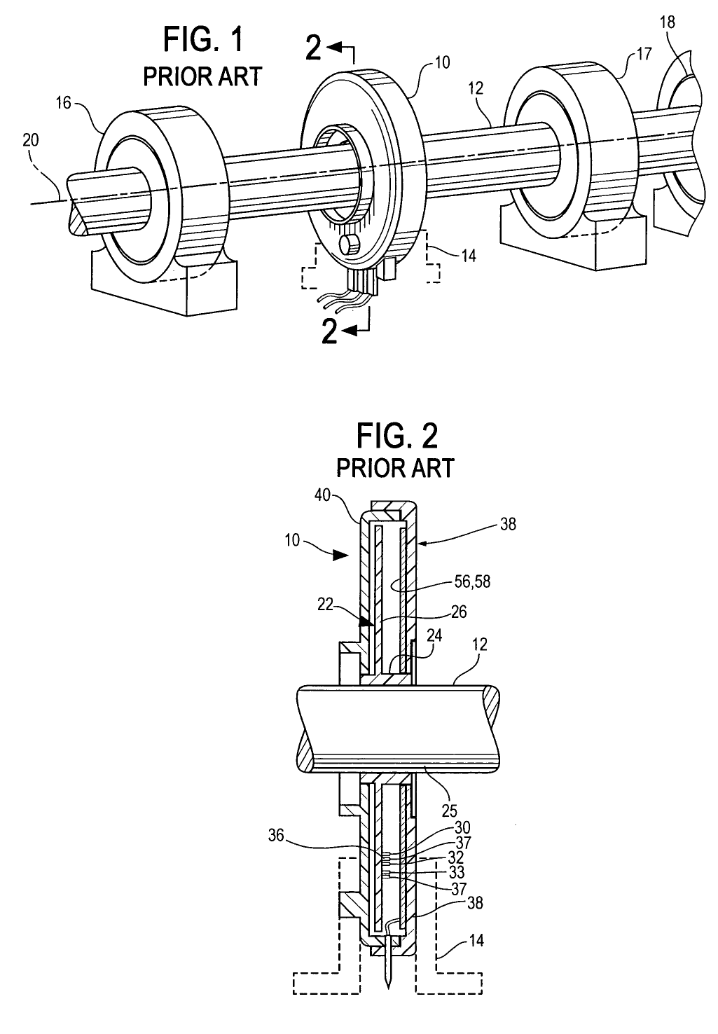

Referring to FIG. 1, an angular position sensor 10 in accordance with the prior art is fitted around a shaft 12 and is retained on mounting 14 by retainers, not shown, of the type well known in the art. The shaft 12 is supported by a plurality of bearings 16, 17, 18 for rotation about its longitudinal axis 20, while the housing 14 and the outer portions of the angular position sensor 10 remain stationary. Since the angular position sensor 10, as shown, is not immediately adjacent any of the bearings 16, 17, 18, and the bearings 16, 17, 18 may not be perfectly aligned with the longitudinal axis 20 of the shaft 12, the shaft 12 will undergo some degree of differential vibration within the angular position sensor 10 as the shaft 12 rotates.

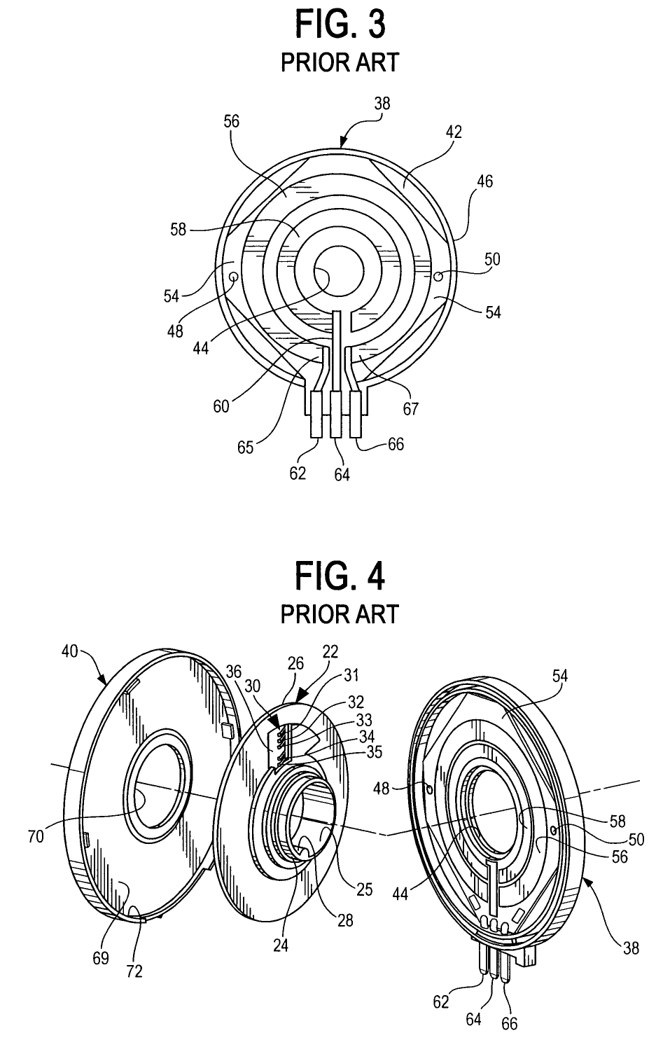

Referring to FIGS. 2 through 4, the angular position sensor 10 includes an annular rotor 22, the body of which has a tubular sleeve portion 24 defining a generally cylindrical central opening 25 sized to slideably receive the shaft 12, and surrounding the sleeve portion 24 is a radial flange 26. Projecting radially inwardly of the central opening 25 is a protrusion 28 for engaging a key slot, not shown, on the shaft 12 such that the rotor 22 will rotate with the shaft 12. Spaced radially outward of each other on the flange 26 are a plurality of electrically conductive brushes 30, 31, 32, 33, 34 made of a spring steel or the like and adapted to extend parallel to one another at different radii from the axis 20 of the shaft 12 and protrude in a direction parallel to the axis 20. The brushes 30-34 are electrically connected to one another on a common buss 36. The sleeve 24 and flange 26 are made of a non-conductive plastic and the flange 26 has a retaining slot into which the buss 36 is cemented, or retained in any other suitable means, so as to rotate with the flange 26.

Surrounding the rotor 22 is a clamshell housing, consisting of a first annular housing member 38 and a second complementarily shaped annular housing member 40. The first housing member 38 includes a web portion 42 having a circular central opening 44, the diameter of which is a little large than the outer diameter of the sleeve 24 of the rotor 22. At the outer circumference of the web portion 42 is a tubular axially extending flange 46. Retained by a pair of retaining pins 48, 50 to the inner surface of the web portion 42 is an annular insulated substrate 54 and printed on the substrate 54 are first and second concentric rings of resistive material 56, 58. The concentric rings 56, 58 are spaced from one another by a distance sufficient to electrically insulate the rings 56, 58 from one another.

As best shown in FIG. 3, neither of the rings 56, 58 scribe an entire circle, but are broken with the ends spaced sufficiently far apart to insulate the ends from each other and to allow a printed connector portion 60 to connect to one end of the inner broken resistive ring 58. The first housing member 38 further includes three connector pins 62, 64, 66, which extend radially outward of the web portion 42 with the central connector pin 64 electrically connected through connector 60 to one end of the inner ring 58 and the outer pins 62, 66 electrically connected at points 65, 67 to opposite ends of the outermost broken resistive ring 56 as shown.

Referring further to FIGS. 2, 3, and 4, the second annular housing member 40 also includes a web portion 69 with a central opening 70 having a diameter a little larger than the outer diameter of the sleeve portion 24 of the rotor 22, and at the outer edge of the web portion 69, a tubular radial flange 72. The tubular radial flange 72 of the second housing member 40 fits within the inner circumference of the tubular radial flange portion 46 of the first housing member 38 for enclosing the rotor 22. With the rotor 22 enclosed in the housing formed by members 38, 40, the brushes 30, 31, 32 will contact the exposed surface of the first ring 56 of resistive material and brushes 33, 34 will contact the second broken ring 58 of resistive material. By connecting an electric potential across the outer pins 62, 66 and connecting an ammeter between the central connector 64 and ground the current measured by the ammeter is related to the angular orientation of the rotor 22 with respect to the housing. By digitizing the current measured and employing a microcomputer, the angular orientation of the brushes 30-34, as they rotate with the shaft 12 with respect to the housing 14 can be electronically displayed in degrees.

By allowing sufficient room within the opposing web portions 42, 68 of the housing members 38, 40 and by providing large enough central openings 44, 70 therein, the rotor 22 may endure the differential vibration that occurs midway along the length of the shaft 12. Nonetheless, as the rotor 22 spins within the interior of the clam shell formed by housing members 38, 40 portions of the rotor will engage portions of the housing members 38, 40 and cause particles of plastic or other material of which the parts are made to interfere with the engagement of the brushes 30-34 against the resistive material of the rings 56, 58 and thereby cause inaccurate readings from the angular position sensor 10.

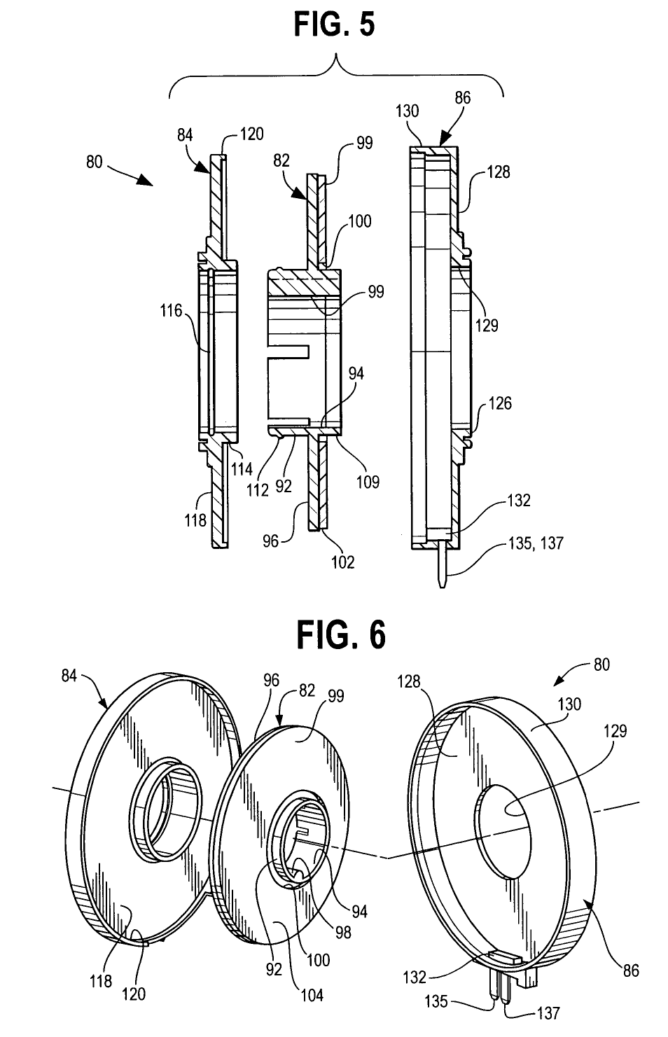

Referring to FIGS. 5, through 7, an angular position sensor 80 in accordance with the present invention includes a rotor 82 rotatably retained within a clamshell housing formed by complementarily shaped first and second housing members 84, 86 respectively. The rotor 82 includes a tubular portion 92 having a central opening 94 sized to slideably receive the shaft 12 and a radial flange portion 96 extending outwardly of the tubular portion 92. The rotor 82 is adapted to be locked for rotation with the shaft by any appropriate means, such as an inwardly projecting ridge 98 suitable for engaging in a key slot in the shaft 12. Preferably, the tubular portion 92 and the radial flange 96 of the rotor 82 are made of a material that is not electrically or magnetically conductive, such as plastic, and are formed as a single part in a mold.

Retained against the radial flange 96 is an annular magnetic member 99 having a circular central opening 100 concentric with the central opening 94 of the rotor 82 and a circular outer circumference 102 having a diameter approximately equal to the circular outer circumference of the radial flange 94. The magnetic member 99 further has parallel generally planar opposing faces, one of which, 104, is visible and the other of which abuts the complementary planar face of the radial flange 94. The unseen planar face is retained against the complementarily shaped radial flange by any suitable means including an adhesive, not shown.

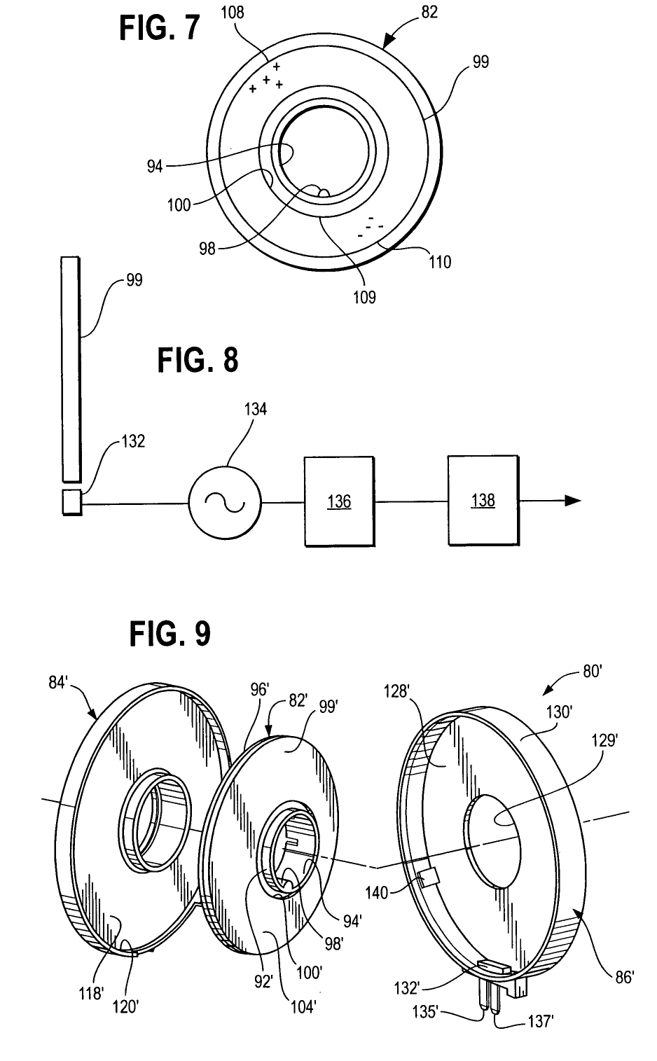

As shown in FIG. 7, a unique feature of the present invention is that the annular magnetic member 99 is magnetized with a positive pole at a point 108 on the outer circumference thereof and a negative pole at a second point 110 on the outer circumference 180 degrees from the positive pole 108. The rotor 82 will therefore have opposing magnetic poles at diametrically opposing positions about its circumference. Rotation of the rotor will therefore cause rotation of the polarity of the magnetic field.

Referring to FIGS. 5, 6, 7, and 8, the first housing member 84 includes a tubular sleeve portion 114, the inner surface of which is polished so as to serve as a bearing and has a diameter sized to rotatably receive the outer surface of the tubular portion 92 of the rotor 82 and an annular groove 116 receives an annular bead 112 on the surface of the tubular portion 92 for maintaining the first housing member 84 in coaxial relationship with the axis of the rotor 92. The first housing member 84 further includes an annular radial web 118 and at the outer circumference of the annular web 118 is a generally tubular shaped flange portion 120.

The second housing portion 86 includes a tubular sleeve portion 126, the inner circumference 129 of which is polished to form a bearing with the outer surface of an extension 109 of the tubular portion 92 of the rotor 82. Extending radially outward of the tubular portion 126 is a web 128, and at the outer circumference of the web 128 is a generally tubular flange portion 130 adapted to engage the tubular flange portion 120 of the first housing member 84 and thereby form a clamshell around the rotor 82.

Positioned on the flange portion 130 of the second housing member 86 is a magnetic detector 132. The magnetic detector may be of any type known in the art for detecting the magnetic field generated by the magnetic member 99, for example, a hall effect detector or a coil. The magnetic detector 132 is positioned on the first housing member 94 so as to respond to the magnetic field generated by the rotating magnetic member 99. The magnetic detector 132 has output leads 135, 137 for electrically connecting the magnetic detector 132 into a circuit that includes a converter .136 and a microcomputer 138.

Referring to FIG. 8, the rotation of the magnetic member 99 adjacent the magnetic detector 132 will cause the magnetic detector 132 to generate an electric potential, the graph of which is a wave 134. The voltage output from the magnetic detector 132 may therefore be directed through an analog to digital converter 136 and the digital output from the converter 136 is directed to a microcomputer 138 to convert the digital output of the wave 134 into a suitable numerical reading of angular orientation, such as a reading in degrees. The output from the microcomputer 138 may therefore be used to identify the exact angular orientation of the shaft 12. It may be necessary to calibrate the output of the microcomputer 138 against the position of the poles 108, 110 on the rotor 82 to compensate for any phase shift of the wave 134.

Referring to FIG. 9 in which an angular position sensor 80′, in accordance with a second embodiment of the invention, is depicted in which the parts thereof that are identical to those of the first embodiment bear identical indicia numbers except they are primed. Like the first embodiment, the position sensor 80′ has first and second housing members 84′, 86′ respectively which enclose a rotor 82′ having an annular magnetic member 99′ mounted thereon similar to the parts of the first embodiment.

A first magnetic detector 132′ is positioned on the flange portion 130′ of the second housing member 86′ and a second magnetic detector 140 is positioned on the flange portion 130′ at a location that is not 180 degrees from the location of the first magnetic detector 132′. The signal generated from both the first and the second magnetic detectors 132′, 140′ are directed through converters, not shown, to a microcomputer, also not shown. The provision of a second magnetic detector 140 enables the microcomputer 138 to determine the direction of rotation of the rotor 82′, and therefore of the direction of rotation of the shaft 12.

While the present invention has been described with respect to two embodiments, it will be appreciated that many modifications and variations may be made without departing from the true spirit and scope of the invention. It is therefore the intent of the independent claims to cover all such variations and modifications which fall within the true spirit and scope of the invention.

What is claimed:

1. An angular position sensor for determining the angular orientation of a shaft rotatable with respect to a stationary body, said angular position sensor comprising:
a rotor having a bore sized to receive said shaft,
said rotor having a circumference,
at least one magnetic member on said rotor,
said at least one magnetic member having a magnetic pole at a first position on said circumference of said rotor,
a housing surrounding a portion of said rotor,
means for maintaining said housing stationary against rotation with said shaft, and
detection means on said housing adjacent said circumference of said rotor for detecting the magnetic polarity of a portion of said rotor nearest said detection means.

2. An angular position sensor in accordance with claim 1 wherein said at least one magnet member on said rotor has a second magnetic pole at a second position on said circumference of said rotor that is 180 degrees from said magnetic pole.

3. An angular position sensor in accordance with claim 1 wherein said at least one magnetic member is an annular member with a central opening concentric with a central opening in said rotor.

4. An angular position sensor in accordance with claim 1 and further comprising means responsive to said detection means for generating a wave indicative of said magnetic polarity detected by said detection means, whereby said wave is indicative of the angular orientation of said shaft with respect to said stationary body.

5. An angular position sensor in accordance with claim 4 and further comprising an analogue to digital converter for converting said wave to a digital output.

6. An angular position sensor in accordance with claim 1 and further comprising a second detection means on said housing angularly spaced from said detection means, said angular spacing is other than 180 degrees from said detector means wherein a direction of rotation may be determined.
